(19) United States
(12) Patent Application Publication
(10) Pub. No.: US 2024/0232472 A1
(43) Pub. Date: Jul. 11, 2024

(54) MULTI-ASSET PLACEMENT AND SIZING FOR ROBUST OPERATION OF DISTRIBUTION SYSTEMS

(71) Applicant: Siemens Corporation, Washington, DC (US)

(72) Inventors: Yubo Wang, Princeton, NJ (US); Ulrich Muenz, Princeton, NJ (US); Suat Gumussoy, Princeton, NJ (US)

(73) Assignee: Siemens Corporation, Washington, NJ (US)

(21) Appl. No.: 18/558,212

(22) PCT Filed: Aug. 27, 2021
(86) PCT No.: PCT/US2021/047932

§ 371 Date: Oct. 31, 2023

(51) Int. Cl. G06F 30/20; G06N 3/092

(52) U.S. Cl. CPC G06F 30/20; G06N 3/092

(57) ABSTRACT

A method for adding assets to a distribution network includes using a placement generation engine to generate discrete placements of assets to be added to the distribution network subject to asset-installation constraint(s). Each placement is defined by a mapping of an asset, from multiple assets of different sizes, to a placement location defined by a node or branch of the distribution network. Each placement is used to update an operational circuit model of the distribution network for tuning control parameters of one or more controllers of the distribution network for robust operation over a range of load and/or generation scenarios. A cost function is evaluated for each placement based on a simulated operation. Parameters of the placement generation engine are iteratively adjusted based on the evaluated cost functions to arrive at an optimal placement and sizing of assets to be added to the distribution network.

### TECHNICAL FIELD

The present disclosure relates generally to the context of electrical power distribution systems, and in particular, to a technique for placement and sizing of assets such as distributed energy resources in a distribution network that ensures robust operation of the distribution network.

### BACKGROUND

Distributed energy resources (DER) are physical and virtual assets that are deployed across a distribution grid, typically close to load, which can be used individually or in aggregate to provide value to the grid, individual customers, or both. Examples of DERs include renewable generation sources such as photovoltaic (PV) panels, energy storage systems such as batteries, electric vehicle (EV) chargers, etc. Distributed generation and storage may enable the collection of energy from many sources and may lower environmental impacts.

Electric utility companies are usually responsible for ensuring smooth operation of their services, particularly, on the distribution side. In order to achieve this goal, existing assets (e.g., DERs, voltage regulators, reactive power compensators, etc.) may be managed and controlled within a smart grid. Over time, it is common for the load and renewable power fluctuations in the grid to increase, for example, due to the high penetration of house-hold PV panels that are connected to the grid. As a result, utility companies may have to periodically invest in additional assets, for example, to meet the load requirements and/or improve voltage regulation to overcome the issue of overvoltage arising due to addition of renewable generation sources. Placement and sizing of assets in distribution networks is a critical task for utility companies, even more so with the future massive increase in renewable generation sources and EV chargers in distribution systems. Improper placement and sizing for DERs and other assets may result in larger investments, sub-optimal voltage profiles, more circulating reactive power, etc.

Optimal sizing and placement of single assets in distribution networks has been long studied. With the increasing penetration of DERs, there exists a need for a scalable approach, specifically, if it is desired to consecutively place multiple assets in the distribution network.

### SUMMARY

Briefly, aspects of the present disclosure provide a technique for placement and sizing of multiple assets in a distribution network that ensures robust operation of the distribution network, addressing at least some of the above-mentioned technical problems.

A first aspect of the disclosure provides a computer-implemented method for adding assets to a distribution network. The distribution network comprises a plurality of existing grid assets and one or more controllers for controlling operation of the distribution network. The method comprises generating, by a placement generation engine, discrete placements of assets to be added to the distribution network subject to one or more asset-installation constraints. Each placement is defined by a mapping of an asset, from among a plurality of available assets of different sizes, to a placement location defined by a node or a branch of the distribution network. The method further comprises using each placement to update an operational circuit model of the distribution network comprising a power flow optimization engine and a simulation engine. The method comprises using the power flow optimization engine to tune control parameters of the one or more controllers of the distribution network control parameters of the one or more controllers for robust operation of the distributed network over a range of load and/or generation scenarios, and using the simulation engine to simulate an operation of the distribution network the tuned control parameters over a period, to evaluate a cost function for that placement. The method further comprises iteratively adjusting parameters of the placement generation engine based on the evaluated cost functions of generated placements to arrive at an optimal placement and sizing of assets to be added to the distribution network.

A further aspect of the disclosure provides a method for adapting a distribution network to a long-term increase in load and/or generated power fluctuation by placing additional assets in the distribution network based on an optimal placement and sizing of assets determined by the above-described method.

Other aspects of the present disclosure implement features of the above-described methods in computing systems and computer program products.

Additional technical features and benefits may be realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The foregoing and other aspects of the present disclosure are best understood from the following detailed description when read in connection with the accompanying drawings. To easily identify the discussion of any element or act, the most significant digit or digits in a reference number refer to the figure number in which the element or act is first introduced.

FIG. 1 is a schematic diagram illustrating an example of a distribution network where optimal placement and sizing of multiple additional assets can be implemented in accordance with aspects of the present disclosure.

FIG. 2 is a schematic block diagram of a system that supports optimal placement and sizing of multiple assets in a distribution network according to an aspect of the disclosure.

FIG. 3 shows an example of logic that a system may implement to support optimal placement and sizing of multiple assets added in sequence to a distribution network using a reinforcement learning agent, according to an example embodiment of the disclosure.

FIG. 4 shows an example of a computing system that supports optimal placement and sizing of multiple assets in a distribution network according to aspects of the present disclosure.

### DETAILED DESCRIPTION

Various technologies that pertain to systems and methods will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

Utilities often find the need to invest in additional grid assets to cope with ever increasing loads and generation fluctuations caused by high penetration of renewable distributed energy sources (DER) deployed in the distribution network. An increasing penetration of renewable DERs such as photovoltaic (PV) panels can turn the slow trend of the net load profile into a fast dynamic trend, which brings with it challenges to operation including voltage regulation issues and high circulating reactive power. This may necessitate additional assets such as voltage regulators, reactive power compensators and energy storage systems such as batteries to be deployed in the distribution network. It has been found that in particular, energy storage batteries are particularly suitable for achieving flexible active power control and solving overvoltage issues stemming from the introduction of PV panels.

Addition of assets may involve solving an optimization problem constrained by the total allowable investment in new assets and other asset-installation constraints. The cost associated with an asset may be directly correlated with the “size” of the asset. For example, the size of an energy storage device, such as a battery, may be defined in terms of its energy storage capacity (e.g., in kWh units), or power (e.g., kW units), or a combination of both. The size of a generation source, such as a PV panel, is usually defined in terms of its active power generation capacity (e.g., kW units). For an asset of a given size, the placement of the asset in the distribution network influences how different nodes of the distribution network interact with each other. Placement, in combination with sizing, thus constitute technical features that may be optimized to solve the technical problem stated above.

The optimal placement and sizing of assets have been long studied, where a typical approach is to formulate the sizing and placement as optimization variable and solve an optimization problem using solvers. An example of this approach is described in the publication: Nazaripouya, H., Wang, Y., Chu, P., Pota, H. R. and Gadh, R., 2015, July. Optimal sizing and placement of battery energy storage in distribution system based on solar size for voltage regulation. In 2015 IEEE Power & Energy Society General Meeting (pp. 1-5). IEEE.

State-of-the-art solutions, such as in the above-mentioned publication, focus on sizing and placing one asset at a time, with no relationship between different assets. Moreover, such solutions do not take into account dynamic effects, such as unpredictable changes in load, infeed power fluctuations and faults.

Aspects of the present disclosure provide a technical solution for supporting utilities to optimize the number, sizing and placement of multiple assets to be added to an electrical distribution network, subject to underlying constraints, to provide robust operation of the distribution network against a range of uncertainty in operation.

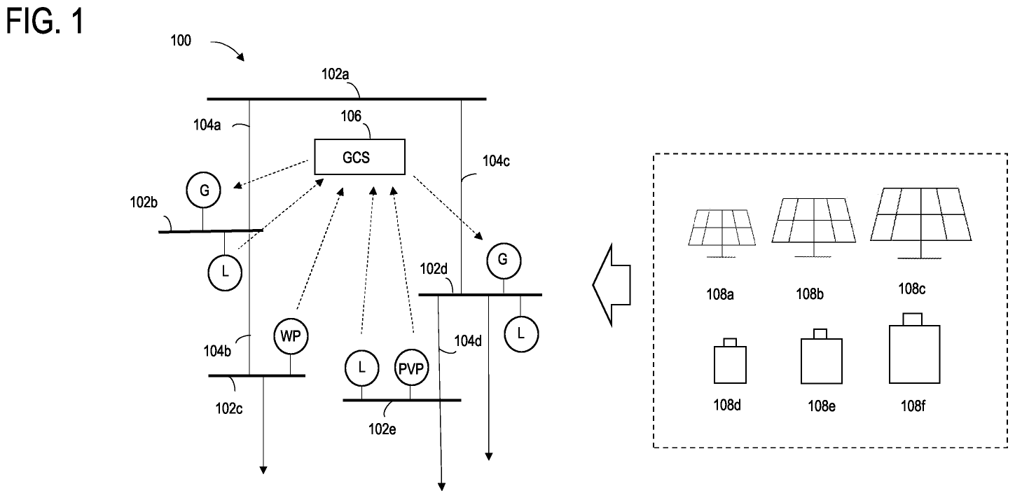

Turning now to the drawings, FIG. 1 shows an example of a distribution network 100 where optimal placement and sizing of multiple additional assets can be implemented in accordance with the methodology disclosed herein. The illustrated distribution network 100 comprises nodes or buses 102a, 102b, 102c, 102d, 102e connected by branches or power distribution lines 104a, 104b, 104c, 104d in a radial tree topology. The shown topology of the distribution network is illustrative and simplified. The disclosed methodology is not limited to any particular type of network topology and can be applied to large distribution networks comprising several nodes and branches. The distribution network 100 may have existing grid assets that can include a number of DERs such as wind parks (WP), photovoltaic parks (PVP), etc., in addition to conventional generators (G), such as powerplants. As shown, some of the nodes may have loads (L) and/or generators (G) and/or DERs connected to them, while others may have no power consumption or injection (zero-injection nodes). The distribution network 100 comprises at least one but typically several controllers, such as voltage regulators, converters, and local controllers of generators (G). The distribution network 100 may also comprise a centralized grid control system (GCS) 106 communicating with the one or more controllers, that can tune control parameters of these controllers to provide optimized operation of the distribution network 100 (e.g., maintaining tolerances in voltage, reactive power, line losses, etc.) against fluctuations in loading and generation (e.g., from renewable DERs such as WP and PVP).

To adapt the distribution network 100 to a long-term increase in load and/or generated power fluctuation, additional assets can be placed in the distribution network 100 based on an optimal placement and sizing of assets as per the disclosed methodology. In the illustrative example, two types of assets of three different sizes each are shown, namely, PV panels 108a, 108b, 108c and energy storage batteries 108d, 108e and 108f. In various embodiments, the disclosed method can be implemented for fewer or more types of assets that can be added to the distribution network 100. In addition to PV panels and batteries, other types of assets that can be added include electric vehicle (EV) chargers, voltage regulators, reactive power compensators etc. Furthermore, the number of discrete sizes available for each type of asset can vary.

The problem to be solved by the disclosed methodology is to determine an optimal sizing, placement and number of assets that can be added to the distribution network that achieves a desired technical result while satisfying one or more asset-installation constraints. A technical result in this case can be to maximize robust control of the distribution network against unpredictable changes, such as load variations, EV charger changes, PV infeed changes, or faults, e.g., during snowstorms, wildfires or hurricanes. Asset-installation constraints can include one or more of: maximum total investment on additional assets, maximum number of assets allowed, among others. For each asset to be added, the possible placement locations may be defined by the nodes of the distribution network. In some embodiments, for example, when line voltage regulators are to be added, the possible placement locations can include branches of the distribution network. A given location (node or branch) may be used for placing multiple additional assets. Furthermore, identical assets (same type and size) may be placed in multiple placement locations. In large distribution networks, the total number of placement locations to be evaluated may be reduced to a compact representation by applying topology embedding, as is well-known in the art.

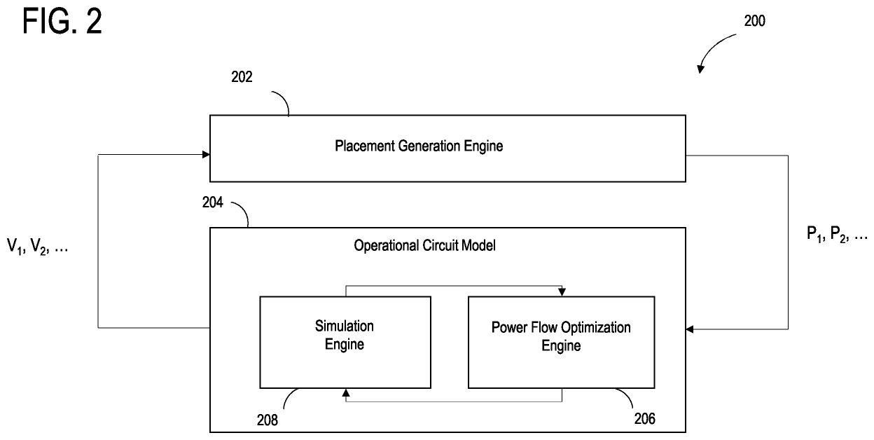

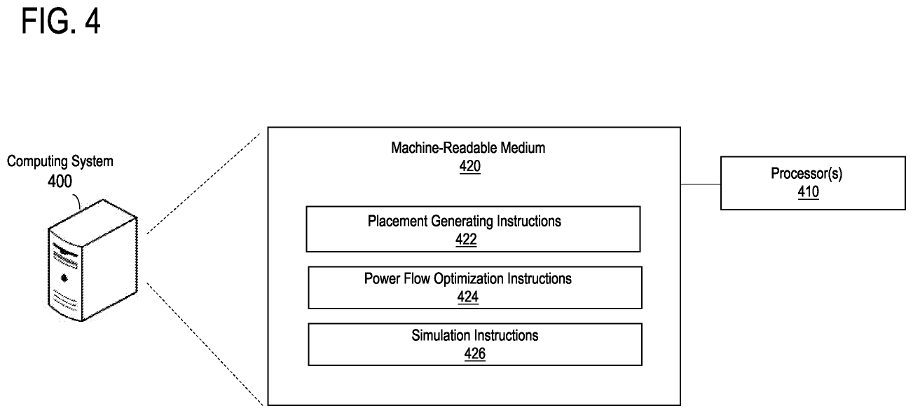

FIG. 2 illustrates a system 200 that supports optimal placement and sizing of multiple assets in a distribution network according to an aspect of the disclosure. The system 200 comprises a placement generation engine 202 that interacts with a power flow optimization engine 206 and a simulation engine 208 which are part of an operational circuit model 204 of a distribution network, such as the distribution network 100 shown in FIG. 1, to solve a problem such as one formulated above. The engines 202, 206 and 208, including components thereof, may be implemented by a computing system in various ways, for example, as hardware and programming. The programming for the engines 202, 206 and 208 may take the form of processor-executable instructions stored on non-transitory machine-readable storage mediums and the hardware for the engines 202, 206 and 208 may include processors to execute those instructions. An example of a computing system for implementing the engines 202, 206 and 208 is described below referring to FIG. 4.

Still referring to FIG. 2, the placement generation engine 202 operates to generate discrete placements of assets to be added to the distribution network subject to one or more asset-installation constraints. The one or more asset-installation constraints define a relationship between the assets to be added, such as the maximum total investment on assets to be added, and/or a maximum number of assets that can be added, which constrains the placement generation. Each placement is defined by a mapping of an asset, from among a plurality of available assets of different sizes, to a placement location. In a problem of placing DERs (e.g., assets 108a-f shown in FIG. 1), the placement locations are defined by the nodes of the distribution network. For certain types of assets (e.g., voltage regulators) the placement locations may be defined by the branches of the distribution network. Depending on the set of available assets to be placed, the placement locations may include the nodes and/or the branches of the distribution network. The placement generation engine 202 generates discrete placements (P₁, P₂, . . . ) using learning parameters that can be adjusted based on a respective value (V₁, V₂, . . . ) of each placement, such that those parameters eventually learn to output an optimal solution. The placement generation engine 202 can include any suitable integer optimization engine, such as a reinforcement learning (RL) agent, an evolutionary learning algorithm such as a genetic algorithm, a gradient free optimization algorithm such as a hill-climbing algorithm, among others.

Each placement (P₁, P₂, . . . ) generated by the placement generation engine 202 is fed to the operational circuit model 204, which is updated by the asset(s) added as per that placement. The operational circuit model 204 is then used to generate the respective value (V₁, V₂, . . . ) for that placement. The operational circuit model 204 may include, for example, a power system model used by a utility company for operational planning in connection with the distribution network 100. As such, the operational circuit model 204 may incorporate a digital twin of the distribution network 100. Within the operational circuit model 204, the power flow optimization engine 206 can be deployed in a simulation environment to tune control parameters of the one or more controllers (e.g., voltage regulators, local asset controllers, etc.) of the distribution network for robust operation over a range of load and generation scenarios, taking into account asset(s) added as per each placement. A simulation engine 208 simulates an operation of the distribution network with the added asset(s) and the tuned control parameters over a defined period (e.g., 2-6 months in simulation timescale), to evaluate a cost function for each placement. The cost function is evaluated over the simulated period based on a dynamic interaction between the power flow optimization engine 206 and the simulation engine 208. The evaluated cost function is used to arrive at a respective value (V₁, V₂, . . . ) for each placement (P₁, P₂, . . . ). Thus, as per the disclosed methodology, the operational circuit model 204 is used for optimizing (tuning) control of the distribution network for a fixed placement scenario generated by the placement generation engine 202.

The power flow optimization engine 206 may integrate a power system model of grid components that include existing assets and new asset(s) added by the current placement, control parameters of the one or more controllers, uncertainties and grid constraints into a robust optimization problem to optimize (e.g., minimize) a pre-defined cost function, to tune the control parameters such that steady-state limits are satisfied for all admissible generation and load variations. The uncertainties may be assumed to lie inside a known norm-bounded set. For example, the uncertainties can be defined by tolerance intervals of load and/or infeed active power (e.g., from renewable DERs) in the distribution network production in a given horizon in the future (e.g., 15-60 minutes in simulation timescale). The grid constraints to be satisfied can include, for example, tolerance intervals of power line, converter and generator active power, AC grid frequency, voltage in DC buses, etc. The control parameters that may be tuned by the power flow optimization engine 206 can include, for example, reference voltage setpoint of voltage regulators, active power setpoint and droop gains of converters and conventional generators (e.g., power plants), etc.

The cost function can be a function of one or more of the following circuit parameters, namely: total reactive power in the distribution network 100, power losses in the distribution network 100, and instances of voltage violation in the distribution network 100. The cost function may be formulated as a linear, quadratic or polynomial function of one or more of the above circuit parameters. In some embodiments, the cost function may be formulated as a weighted function of the above circuit parameters.

A method for robust control of grids based on optimization of a pre-defined cost function is described in the publication: A. Mešanović, U. Münz and C. Ebenbauer, “Robust Optimal Power Flow for Mixed AC/DC Transmission Systems With Volatile Renewables,” in IEEE Transactions on Power Systems, vol. 33, no. 5, pp. 5171-5182, September 2018, doi: 10.1109/TPWRS.2018.2804358.

Other methods are described in U.S. Pat. Nos. 10,416,620 and 10,944,265.

Depending on the specific application, the presently disclosed methodology may use or adapt any of the above-referenced methods or use any other method to solve a robust optimization problem to tune one or more controllers of the distribution network for each placement (P₁, P₂, . . . ) generated by the placement generation engine 202. The disclosed methodology then involves evaluation of the cost function over a period of simulated operation to arrive at a value (V₁, V₂, . . . ) for each generated placement.

The cost function may be evaluated by discretizing power flow into smaller intervals (e.g., one hour in simulation timescale) within the period of simulated operation (e.g., two months in simulation timescale) and sampling circuit function parameters such as total reactive power, total losses in power lines, and instances of voltage violation in the distribution network. A cumulative or average value of the cost function for the duration of the simulated period can be used to arrive at the value (V₁, V₂, . . . ) of each placement (P₁, P₂, . . . ). For example, the value of a placement may utilize a negative of the cumulative or average value of the cost function over the simulated period, such that a lower cost implies a higher value for a placement.

The respective values (V₁, V₂, . . . ) of individual placements (P₁, P₂, . . . ) are fed back to the placement generation engine 202. The parameters of the placement generation engine 202 are iteratively adjusted based on the values (V₁, V₂, . . . ) of generated placements (P₁, P₂, . . . ) to arrive at an optimal placement and sizing of assets to be added to the distribution network 100.

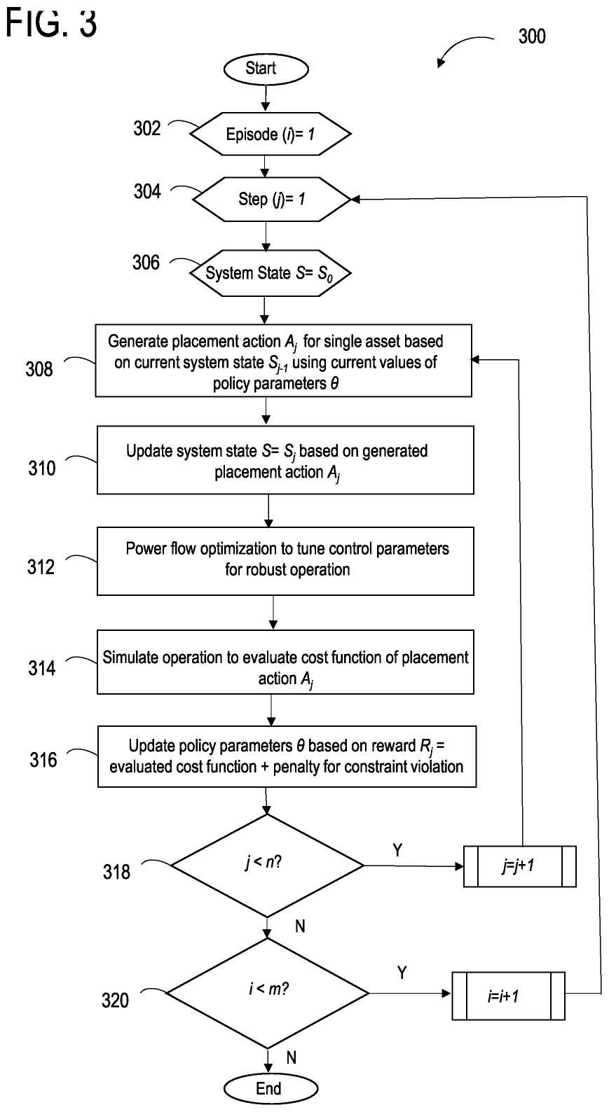

In some embodiments, such as with an RL agent, multiple assets may be placed by sequentially placing one asset at a time. In this case, each placement (P₁, P₂, . . . ) generated by the placement generation engine 202 is defined by a mapping of a single asset to a single placement location. This approach, which is illustrated below with reference to FIG. 3, arrives at an optimal sequence, placement location and sizing of assets to be added to the distribution network. The approach is particularly suitable in supporting utilities to add assets to the distribution network (i.e., incur costs) in a phased manner, allowing additional assets to be placed in the distribution network sequentially with an interval of operation (e.g., a few months) between consecutive placements. In other embodiments, such as with a genetic algorithm, multiple assets may be placed simultaneously. In that case, each placement (P₁, P₂, . . . ) generated by the placement generation engine 202 may be defined by a mapping of multiple assets to one or more placement locations.

In an exemplary embodiment of the disclosed methodology, the placement generation engine 202 comprises an RL agent that may be used to solve the optimal placement and sizing problem via a sequential decision-making process. The RL agent may be defined by two main components, namely a policy and a learning engine. The RL problem can be formulated as a Markov Decision Process (MDP), that relies on the Markov assumption that the next state depends only on the current state and is conditionally dependent on the past.

The policy can include any function, such as a table, a mathematical function, or a neural network, that takes in at each step a state as input and outputs an action. The state received as input can include a snapshot of the current topology of the distribution network (e.g., a graph embedding) with assets that may have been added as per any prior placement in the current episode of trials. The action may include a placement of no more than a single asset (e.g., with “no placement” being one of the possible actions). The action space is defined by the number of available assets of different types and sizes and the number of placement locations such as nodes and/or branches. A given location (node or branch) may be used for placing multiple additional assets. Furthermore, identical assets (same type and size) may be placed in multiple placement locations. For instance, in illustrative example shown in FIG. 1, there are 6 DERs assets that can be placed in 5 nodes, whereby the action space can include a maximum of 30 possible placements. Furthermore, in one implementation, “no placement” actions can be included in the action space, for example, by defining an additional size “zero” of the assets to be added, such that placing an asset of “zero” size effectively amounts to no-placement action. As mentioned above, for, the total number of placement locations to be evaluated may be reduced by applying topology embedding, which can effectively reduce the action space for large networks.

The RL agent operates by executing an action of placing a single asset (P₁, P₂, . . . ), which may include a “no-placement” action, collecting a reward defined by the value (V₁, V₂, . . . ) of that placement obtained using the operation circuit model 204 and using the learning engine to adjust policy parameters of the policy function. The policy parameters are adjusted such that a cumulative reward over an episode is maximized subject to the one or more asset-installation constraints, where an episode comprises a pre-defined number of steps. Convergence may be achieved after executing a pre-defined number of episodes by the RL agent. The number of episodes and the number of steps per episode may be defined as hyperparameters of the learning engine.

In a particularly suitable implementation, the policy of the RL agent may include a neural network. The neural network can comprise an adequately large number of hidden layers of neuronal nodes and number of neuronal nodes per layer to approximate input-output relationships involving large state and action spaces. Here, the policy parameters may be defined by the weights of the respective neuronal nodes. The architecture of the neural network, such as the number and layers of nodes and their connections, may be a matter of design choice based on the specific application, for example, to achieve a desired level of function approximation while not incurring high computational costs.

The learning engine can comprise a policy-based learning engine, for example, using a policy gradient algorithm. A policy gradient algorithm can work with a stochastic policy, where rather an outputting a deterministic action for a state, a probability distribution of actions in the action space is outputted. Thereby, an aspect of exploration is inherently built into the RL agent. With repeated execution of actions and collecting rewards, the learning engine can iteratively update the probability distribution of the action space by adjusting the policy parameters (e.g., weights of the neural network). In another example, the learning engine can comprise a value-based learning engine, such as a Q-learning algorithm. Here, the learning engine may output an action having the maximum expected value of the cumulative reward over the episode (for example, applying a discount to rewards for future actions in the episode). After the action is executed and a reward is collected, the learning engine can update the value of that action in the action space based on the reward it just collected for the same action. In still other examples, the learning engine can implement a combination of policy-based and value-based learning engines (e.g., implementing an actor-critic method using a combination of neural networks).

FIG. 3 shows an example of logic 300 that a system may implement to support optimal placement and sizing of multiple assets added in sequence to a distribution network. The logic 300 may be implemented by a computing system (e.g., as shown in FIG. 4) as executable instructions stored on a machine-readable medium. The computing system may implement the logic 300 via the placement generation engine 202 comprising an RL agent, the power flow optimization engine 206 and the simulation engine 208.

The logic 300 includes repeatedly executing a number of episodes of trial where every episode comprises a pre-defined number of steps, which is denoted herein by a hyperparameter n. For implementing the logic 300, an episode counter i is initialized (block 302), a step counter j is initialized (block 304) and the system state S of the distribution network is initialized to S₀ (block 306). The initialized system state S₀ may represent an initial topology of the distribution network with the existing grid assets prior to any assets being added. The RL agent includes a policy parametrized by θ. At the commencement of the process driven by the logic 300, the policy parameters θ may have arbitrary initial values assigned to them.

Continuing with reference to FIG. 3, at each step j, single asset placements A₁ are discretely generated by the RL agent based on the current system state Sⱼ₋₁ as input, using current values of the policy parameters θ (block 308). The action A₁ may be generated from an action space of the RL agent with the objective of maximizing a cumulative reward over the episode i. The state and the action space may be defined, for example, as described above.

For example, if the RL agent includes a policy-based learning engine (e.g., using a policy gradient or actor-critic method), then at block 308 of the logic 300, based on the current system state Sⱼ₋₁ at each step j, the output of the RL agent in that step may include a probability distribution representing a probability of assigning each asset to each placement location in the action space. A placement action Aⱼ may be selected by sampling the output probability distribution or taking an argmax of the output probability distribution.

On the other hand, if the RL agent includes purely a value-based learning engine (e.g., using a Q-learning method), then at block 308 of the logic 300, based on the current system state Sⱼ₋₁ at each step j, the output of the RL agent in that step may include an expected value of the cumulative reward over the episode i of assigning each asset to each placement location in the action space. The expected value of the cumulative reward may be determined by applying a discount to rewards for future actions in the episode i. A placement action A may be selected that has the maximum expected value of the cumulative reward in the action space.

The placement action A₁ generated at block 308 can, in some cases, include a “no-placement” action, as described above. The RL agent can be trained to select such an action if an asset-installation constraint (e.g., maximum total investment and/or maximum number of assets that can be installed) is violated or close to being violated by preceding placement actions in the current episode. This can be learned by the RL agent by introducing penalties in the reward Rⱼ for a placement action when that placement action leads to a violation of one or more of the asset-installation constraints. By repeatedly rewarding actions in this manner, the RL agent can learn to push “no-placement” actions to the end of an episode while a consecutive sequence of positive placement actions can be executed at the beginning of the episode.

The logic 300 then updates the system state S with the generated placement action A₁ (block 310). The updated system state is now Sⱼ.

Based on an updated power system model of the distribution network resulting from the placement action Aⱼ, a power flow optimization is executed (block 312), for example, by the power flow optimization engine 206, to tune control parameters of one or more controllers of the distribution network for robust operation of the distribution network. An operation of the distribution network with the added asset as per the placement action Aⱼ and the tuned control parameters is simulated (block 314) for a defined period in simulation timescale, for example, by the simulation engine 208, to evaluate a cost function over the simulated period. Exemplary operational steps executed by the power flow optimization engine 206 to solve a robust optimization problem and operational steps executed by the simulation engine 208 to evaluate a cost function over a simulated period are described above in the present specification.

The evaluated cost function is used to define a reward Rⱼ for the placement action Aⱼ. For example, the Rⱼ reward may comprise two components. A first reward component may comprise the evaluated cost function, for e.g., defined as a negative of the cumulative or average value of the cost function over the simulated period, such that a lower cost implies a higher value for a placement action. A second reward component may comprise a penalty quantifying a violation of an asset-installation constraint. The reward Rⱼ is used to update the policy parameters θ of the RL agent (block 316), which then define the current values of the policy parameters for the next step j=j+1.

Each episode i is executed by sequentially executing n steps, after which anew episode i=i+1 commences with an initialized system state S₀ (block 306) but with the updated policy parameters θ. Every episode thus involves a sequential placement of up to a maximum of n assets of different types and sizes, subject to specified asset-installation constraint(s) being satisfied. With repeated execution of a large number of episodes, the RL agent can learn to determine an optimal number, type and sizing of assets to be placed in the distribution network, from among the available assets to be added, along with an optimized sequence of placement. In the illustrated logic 300, the learning engine executes a pre-defined number of episodes, denoted by a hyperparameter m. The step counter j and the episode counter i are evaluated against the respective pre-defined values n and m at decision blocks 318 and 320 respectively of the logic 300. In other embodiments, instead of or in addition to using the hyperparameter m, other convergence criteria may be used by the learning engine to terminate the logic 300.

Depending on the sequence in which assets are installed, identical final placements of the same set of assets may still incur different operational losses during a phased installation of these assets in the distribution network. The RL agent can learn an optimum sequence by updating its policy based on the reward for each step of single asset placement, such that the cumulative reward at the end of an episode is maximized. The learned sequence can support a utility company to implement a strategically phased addition of assets to the distribution network, minimizing operational losses such as power line losses, voltage violations, circulating reactive power, etc.

Embodiments of the disclosed methodology are distinct from methods that use optimization solvers in combination with circuit models to optimize placement and sizing, such as in the identified state-of-the-art. Such state-of-the-art methods typically require a customization of the circuit model, where a large amount of effort, largely manual, is usually involved in translating the circuit model to the language of the optimization solver. Moreover, if the circuit model changes, another round of translation may have to be carried out before the method gives any meaningful results. In contrast, in the disclosed methodology, the customization effort is shifted to the placement generation engine 202, allowing it to interact standard operational software. The customization effort in this case involves training of the placement generation engine 202, which is largely automatic, with minimal manual input. As mentioned, the operational circuit model 204 may be already built and in use by the utility company for operational purposes. As per the disclosed methodology, if the operational circuit model changes, only the placement generation engine 202 needs to be reconfigured/retrained, such that the heavy lifting in circuit model translation can be skipped.

Furthermore, state-of-the-art methods usually determine the sizing and placement of a single DER. However, it is unlikely to be the optimal solution for a fixed investment, where multiple DERs and other assets can be more beneficial to the distribution network. In contrast, the disclosed methodology supports placement of multiple assets, and may additionally support sequential placement of multiple assets (e.g., using RL). Also, the integer variables introduced by the placement and sizing problem may limit the problem size when using state-of-the-art methods involving optimization solvers. The disclosed methodology follows a machine learning approach, which can be used to solve for large distribution networks.

FIG. 4 shows an example of a computing system 400 that supports optimal placement and sizing of multiple assets in a distribution network according to the present disclosure. The computing system 400 includes at least one processor 410, which may take the form of a single or multiple processors. The processor(s) 410 may include a central processing unit (CPU), a graphics processing unit (GPU), a microprocessor, or any hardware device suitable for executing instructions stored on a machine-readable medium. The computing system 400 further includes a machine-readable medium 420. The machine-readable medium 420 may take the form of any non-transitory electronic, magnetic, optical, or other physical storage device that stores executable instructions, such as placement generating instructions 422, power flow optimization instructions 424 and simulation instructions 426 shown in FIG. 4. As such, the machine-readable medium 420 may be, for example, Random Access Memory (RAM) such as a dynamic RAM (DRAM), flash memory, spin-transfer torque memory, an Electrically-Erasable Programmable Read-Only Memory (EEPROM), a storage drive, an optical disk, and the like.

The computing system 400 may execute instructions stored on the machine-readable medium 420 through the processor(s) 410. Executing the instructions (e.g., the placement generating instructions 422, the power flow optimization instructions 424 and the simulation instructions 426) may cause the computing system 400 to perform any of the technical features described herein, including according to any of the features of the placement generation engine 202, the power flow optimization engine 206 and the simulation engine 208 described above.

The systems, methods, devices, and logic described above, including the placement generation engine 202, the power flow optimization engine 206 and the simulation engine 208, may be implemented in many different ways in many different combinations of hardware, logic, circuitry, and executable instructions stored on a machine-readable medium. For example, these engines may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine-readable instructions stored on the medium, which when executed in an endpoint, computer system, or other device, cause the device to perform operations according to any of the description above, including according to any features of the placement generation engine 202, the power flow optimization engine 206 and the simulation engine 208. Computer readable program instructions described herein can be downloaded to respective computing/processing devices from a computer readable storage medium or to an external computer or external storage device via a network, for example, the Internet, a local area network, a wide area network and/or a wireless network.

The processing capability of the systems, devices, and engines described herein, including the placement generation engine 202, the power flow optimization engine 206 and the simulation engine 208, may be distributed among multiple system components, such as among multiple processors and memories, optionally including multiple distributed processing systems or cloud/network elements. Parameters, databases, and other data structures may be separately stored and managed, may be incorporated into a single memory or database, may be logically and physically organized in many different ways, and may be implemented in many ways, including data structures such as linked lists, hash tables, or implicit storage mechanisms. Programs may be parts (e.g., subroutines) of a single program, separate programs, distributed across several memories and processors, or implemented in many different ways, such as in a library (e.g., a shared library).

While various examples have been described above, many more implementations are possible.

1. A computer-implemented method for adding assets to a distribution network, the distribution network comprising a plurality of existing grid assets and one or more controllers for controlling operation of the distribution network, the method comprising:
generating, by a placement generation engine, discrete placements of assets to be added to the distribution network subject to one or more asset-installation constraints, where each placement is defined by a mapping of an asset, from among a plurality of available assets of different sizes, to a placement location defined by a node or a branch of the distribution network,
using each placement to update an operational circuit model of the distribution network for:
tuning, by a power flow optimization engine, control parameters of the one or more controllers for robust operation of the distributed network over a range of load and/or generation scenarios, and
simulating, by a simulation engine, an operation of the distribution network with the tuned control parameters over a period, to evaluate a cost function for that placement, and
iteratively adjusting parameters of the placement generation engine based on the evaluated cost functions of generated placements to arrive at an optimal placement and sizing of assets to be added to the distribution network.

2. The method according to claim 1,
wherein the placement generation engine comprises a reinforcement learning (RL) agent including a policy defined by policy parameters,
wherein the placements define actions of the RL agent and the evaluated cost functions are used to define rewards for respective actions for adjusting the policy parameters of the RL agent.

3. The method according to claim 2, wherein the policy includes a neural network and the policy parameters are defined by weights of the neural network.

4. The method according to claim 2, comprising executing a plurality of episodes of trial by the RL agent, where each episode comprises a pre-defined number of steps, wherein executing each episode comprises:
initializing a system state of the distribution network,
generating actions comprising placement of single assets at discrete steps of the episode, wherein the action at each step is generated from an action space of the RL agent based on a current system state such that a cumulative reward over the episode is maximized,
updating the system state based on a placement defined by the generated action at each step, and
adjusting the policy parameters at each step based on a respective reward resulting from the action at that step,
wherein upon completion of the plurality of episodes, the RL agent learns an optimal placement and sizing of assets to be sequentially added to the distribution network.

5. The method according to claim 4, wherein generating actions at discrete steps by the RL agent comprises:
based on the current system state at each step, outputting a probability distribution representing a probability of assigning each asset to each placement location in the action space of the RL agent, and
selecting an action by sampling or taking an argmax of the output probability distribution.

6. The method according to claim 4, wherein generating actions at discrete steps by the RL agent comprises:
based on the current system state at each step, outputting an expected value of the cumulative reward over the episode of assigning each asset to each placement location in the action space of the RL agent, and
selecting an action based on a maximum expected value of the cumulative reward in the action space.

7. The method according to claim 4, wherein an additional size “zero” is defined for the assets to be added, and wherein the action space of the RL agent comprises “no placement” actions that represent placement of assets of “zero” size.

8. The method according to claim 2, wherein the reward for each action comprises a first reward component defined by the evaluated cost function and a second reward component comprising a penalty quantifying a violation of the one or more asset-installation constraints.

9. The method according to claim 1, wherein the assets to be added comprise one or more types of distributed energy resources (DER) of different sizes and the placement locations are defined by nodes of the distribution network.

10. The method according to claim 1, wherein the one or more asset-installation constraints comprise:
maximum total investment on assets to be added, and/or
maximum number of assets that can be added.

11. The method according to claim 1, wherein the control parameters of the one or more controllers are tuned by performing robust optimization of the cost function using tolerance intervals of load and/or infeed active power in the distribution network as robust optimization uncertainties, such that one or more grid constraints are satisfied.

12. The method according to claim 1, wherein the cost function is a function of one or more of:
total reactive power in the distribution network,
power losses in the distribution network, and
instances of voltage violation in the distribution network.

13. The method according to claim 1, wherein the cost function is evaluated by discretizing power flow into smaller intervals within the period of simulated operation.

14. A non-transitory computer-readable storage medium including instructions that, when processed by a computing system, configure the computing system to perform the method according to claim 1.

15. A method for adapting a distribution network to a long-term increase in load and/or generated power fluctuation, the distribution network comprising a plurality of existing grid assets and one or more controllers for controlling operation of the grid assets, the method comprising:
placing additional assets in the distribution network based on an optimal placement and sizing of assets determined by a method according to claim 1.

16. The method according to claim 15, wherein the additional assets are placed sequentially with an interval of operation between consecutive placements.

17. A computing system comprising:
a processor; and
a memory storing instructions that, when executed by the processor, cause the computing system to carry out a method according to claim 1.
